(19) United States
(12) Patent Application Publication
(10) Pub. No.: US 2019/0034877 A1
(43) Pub. Date: Jan. 31, 2019

(54) UNMANNED MOBILE CONTROL POINT PRODUCT DELIVERY SYSTEMS AND METHODS

(71) Applicant: Walmart Apollo, LLC, Bentonville, AR (US)

(72) Inventors: Robert L. Cantrell, Herndon, VA (US); John J. O'Brien, Farmington, AR (US); Nicholas R. Antel, Springdale, AR (US); Donald R. High, Noel, MO (US)

(21) Appl. No.: 16/046,113

(22) Filed: Jul. 26, 2018

Related U.S. Application Data
(60) Provisional application No. 62/537,665, filed on Jul. 27, 2017.

(51) Int. Cl. G06Q 10/08; G05D 1/10; G05D 1/02; B64C 39/02; B60P 1/44

(52) U.S. Cl. CPC G06Q 10/08355; G05D 1/104; B64C 2201/128; B64C 39/024; B60P 1/4414; G05D 1/0291

(57) ABSTRACT

Some embodiments provide aerial retail product delivery system, comprising: unmanned aerial vehicles (UAV); unmanned ground vehicle mobile control points (MCP) each configured to move to a pre-selected intermediate locations; wherein a UAV control circuit is configured to: determine adjustments to a final approach path between the UAV and a MCP to improve an alignment approach at a pre-selected intermediate location by applying a cooperative navigation between the UAV and the MCP as a function of both a first set of navigation data detected by coordination navigation sensor of the UAV, and a second set of navigation data detected by an inbound navigation sensor of the MCP; implement the adjustments to flight of the UAV to modify the final approach path; and direct the transfer of a product to the MCP and to cause the MCP to transport and deposit the product at a delivery location.

### CROSS-REFERENCE TO RELATED APPLICATION

This application claims the benefit of U.S. Provisional Application No. 62/537,665 filed Jul. 27, 2017, which is incorporated herein by reference in their entirety.

### TECHNICAL FIELD

This invention relates generally to unmanned vehicle product delivery.

### BACKGROUND

Getting products to customers is particularly critical to retail entities. Many retail entities provide delivery services to get retail products to customers, or use third party delivery services to get purchased retail products to customers. There is a need to improve the delivery of products to customers.

### BRIEF DESCRIPTION OF THE DRAWINGS

Disclosed herein are embodiments of systems, apparatuses and methods pertaining to the delivery of products to customers through the cooperative use of unmanned vehicles. This description includes drawings, wherein:

FIG. 1 illustrates a simplified block diagram of an exemplary aerial retail product delivery system, in accordance with some embodiments;

FIG. 2 illustrates a simplified overhead view of an exemplary potential delivery area, in accordance with some embodiments;

FIG. 3 illustrates a simplified block diagram of an exemplary UAV, in accordance with some embodiments;

FIG. 4 illustrates simplified block diagram of an exemplary mobile control point, in accordance with some embodiments;

FIG. 5 illustrates a simplified flow diagram of an exemplary process of providing aerial retail product delivery through a cooperation of mobile devices, in accordance with some embodiments; and

FIG. 6 illustrates an exemplary system for use in implementing methods, techniques, systems, circuitry, devices, apparatuses, servers, sources and enabling the delivery of products to customers, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein to enable aerial delivery of retail products. Some embodiments provide an aerial retail product delivery system, comprising: a plurality of unmanned aerial vehicles (UAV) each comprising a UAV control circuit, a coordination navigation sensor or sensor system, and a retail product carrying system. The delivery system further includes a plurality of unmanned ground vehicle (UGV) mobile control points (MCP) each configured to move to a different pre-selected intermediate location that is proximate to but distant from intended delivery locations and to complete the delivery to the respective delivery location. The MCP further includes an MCP control circuit, a product receiving platform, a ground based transport system, and an inbound navigation sensor or sensor system. In some implementations, the UAV control circuit of a UAV is configured to: determine adjustments to a final approach path between the UAV and an MCP to improve an alignment approach between the UAV and the MCP at a pre-selected intermediate location associated with the MCP by applying a cooperative navigation between the UAV and the MCP as a function of both a set of navigation data detected by the coordination navigation sensor of the UAV and that corresponds to the alignment approach between the UAV and the MCP, and a second set of navigation data detected by an inbound navigation sensor of the MCP as the UAV approaches the MCP. The UAV control circuit further implement adjustments to the flight of the UAV to modify the final approach path, and directs the transfer of a product from a retail product carrying system of the UAV to a product receiving platform of the MCP to cause the MCP to transport to and deposit the product at a delivery location that is separate and distant from the pre-selected intermediate location.

In accordance with some embodiments, the aerial retail product delivery system enables the use of unmanned aerial vehicles (UAV) to transport products to be delivered at least a portion of the distance to an intended delivery location even when there are obstacles and/or other factors that can interfere with or prevent the UAV from transporting the product to the delivery location. Often a delivery location may have trees, bushes, heavy street traffic, be within or adjacent to a no-fly-zone, historically had interference, and/or other such factors that can hinder, inhibit or prevent a UAV from making the delivery to an intended delivery location. Accordingly, some embodiments utilize a UAV to transport the one or more products intended for delivery to a predefined intermediate location that has been identified as being safe for the UAV, the intermediate location is not in a no-fly-zone (e.g., government specified, homeowner and/or building-owner specified, school area, airport, military, etc.), and the UAV can readily access the intermediate location. An unmanned ground vehicle (UGV) mobile control point (MCP) similarly can transport itself to the predefined intermediate location to receive the one or more products from the UAV, and complete the delivery to the intended delivery location by ground transportation.

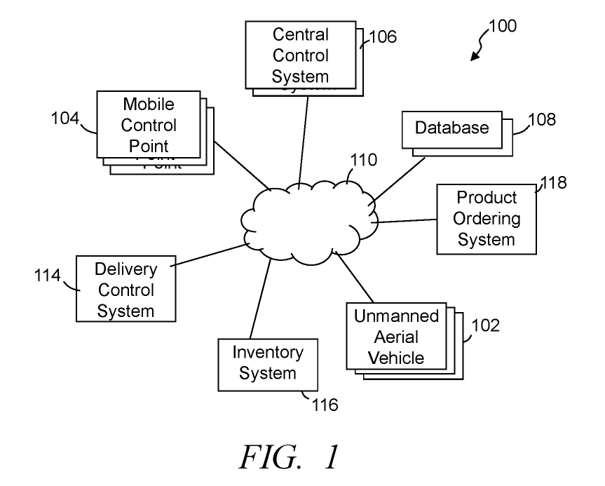

FIG. 1 illustrates a simplified block diagram of an exemplary aerial retail product delivery system 100, in accordance with some embodiments. The delivery system 100 includes multiple unmanned aerial vehicles 102 (UAV) and multiple unmanned ground vehicle mobile control points 104 (MCP). Some embodiments include one or more central control systems 106 that can in part coordinate at least the operation of the UAVs 102. The delivery system 100 typically includes one or more databases 108 that store routing data, mapping data, delivery location information, customer information, product information, UAV parameter information MCP parameter information, and/or other such data. In some embodiments, one or more of the UAVs 102 in communication with the central control system 106 and/or the databases 108 through one or more distributed communication and/or computer networks 110 (e.g., LAN, WAN, Internet, cellular, etc.). Additionally or alternatively, in some embodiments, one or more of the mobile control points 104 are similarly in communication with the central control system 106 and/or the databases 108 over the one or more networks 110. The delivery system 100 further includes and/or is communicatively coupled with one or more delivery control systems 114, one or more inventory systems 116, one or more product ordering systems 118, and/or other systems to enable the purchasing of products and the delivery of products.

The central control system 106, in some embodiments, coordinates the operation of the UAVs 102 and/or mobile control points 104 based on input from the delivery control system 114. In some embodiments, the product ordering system 118 enables customers to place orders for one or more products with at least some of those orders intending to be delivered. The ordering system may be implemented through one or more Internet sites implemented by one or more Internet servers and accessible over the Internet, through software applications (APP) implemented on customers' devices (e.g., smartphones, tablets, smart wearable devices, computers, etc.), and/or through ordering systems at one or more brick-and-mortar retail shopping facilities (which may be utilized directly by customers and/or operated by workers of the shopping facility). The ordering system enables customers to submit orders for one or more products, and request the one or more products be delivered to a desired location, which may be specified at the time of ordering, based on historic delivery location, specified in a customer profile, or the like. In some embodiments, the central control system can directs the inventory system 116 to determine whether the one or more products are available at a retail facility, distribution center, fulfillment center or other facility to supply the product, and/or to initiate an order from a distribution center, fulfillment center, supplier or the like. Further, in some applications, the central control system directs the delivery control system to coordinate the delivery of the one or more products to the intended delivery locations.

In some embodiments, the delivery control system 114 is configured to apply one or more sets of rules to evaluate the one or more products to be delivered, the timing of the delivery (e.g., whether there is a rush, intended for same day delivery, next day delivery, requested window of time of delivery, etc.), size of the one or more products, shape of the one or more products, weight of the one or more products, and/or other such information. Based, at least in part, on the weight of the one or more products, the delivery control system may select aerial delivery as a mode of delivery over other modes of delivery (e.g., unmanned ground vehicle, manned delivery vehicle, third party service (e.g., Fed-Ex, UPS, U.S. Postal Service, etc.), water vehicle, etc.). For example, the rules may restrict aerial delivery to a product or collection of products having a weight of less than a threshold, which is dependent on the UAVs lift capacity). Similarly, the rules may restrict aerial delivery to products having less than one or more dimension, less than a total surface area, and/or other such dimensions which may adversely affect the flight of the UAV. Additionally or alternatively, the rules may limit aerial delivery to products that are within a threshold distance of the intended delivery location and/or are to be transported to be within the threshold distance (e.g., based on a distance threshold of the UAV).

As described above, in some instances, obstacles, restrictions and/or factors may prevent the delivery of one or more products directly by a UAV to the predefined delivery location. Again, there may be one or more trees, bushes, buildings, ground traffic, no-fly-zones, other air traffic, and/or other such factors that can restrict the direct delivery by UAV. Some obstacles may be temporary obstacles (e.g., trucks, cars, temporary no-fly-zones, people within a threshold distance, etc.). In some embodiments, however, the delivery system 100 utilizes distributed mobile control points 104 (MCP) to allow a delivery to be transported a part of the distance to the delivery location by UAV, and the remainder by the mobile control point 104. In some applications, a “control point” is typically a location that is pre-set to receive UAV carried packages, and that is controlled and safe for the UAVs to deposit products and/or retrieve products. Often such control points have restricted access, and is known to be clear of restrictions. Such control points are typically fixed locations over which the retailer has control or a third party has control and with which the retailer has an arrangement. Often, however, such fixed control points cannot be established with a desired proximity of many delivery locations.

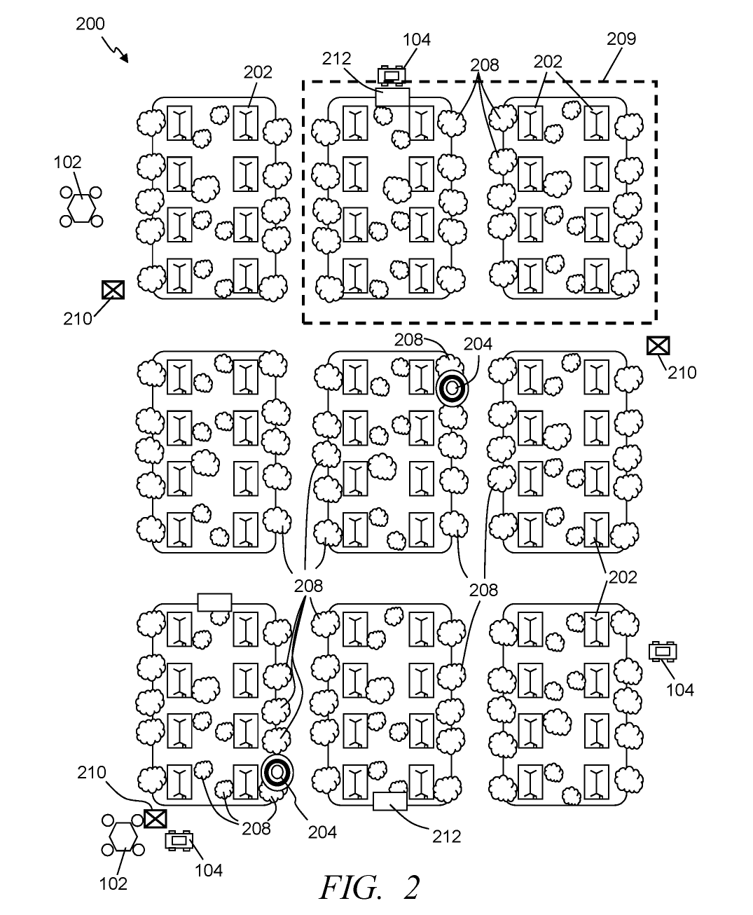

Accordingly, some embodiments, employ the mobile control points 104 that can establish temporary control points, and in some instances provide at least some degree of safety through features of the mobile control points. FIG. 2 illustrates a simplified overhead view of an exemplary potential delivery area 200 (e.g., a residential area, commercial area, etc.), that includes multiple buildings 202 (e.g., homes, apartment buildings, office buildings, manufacturing buildings, retail buildings, etc.) that may correspond to an intended delivery location 204, in accordance with some embodiments. Because of obstacles 208 (e.g., trees, no-fly-zone areas 209, etc.) there are some delivery locations 204 that cannot have direct air delivery by a UAV 102. The mobile control points 104 can move to a pre-selected intermediate location 210 and cooperate with a UAV to obtain the one or more products to be transported by the mobile control point 104 to the one or more intended delivery locations 204 that cannot receive the direct aerial delivery.

FIG. 3 illustrates a simplified block diagram of an exemplary UAV 102, in accordance with some embodiments. The UAV 102 includes one or more UAV control circuits 302, and lift and transport systems 304 that include one or more motors and propellers that provide the UAV with lift and can move the UAV in desired directions. The UAV control circuit 302 includes and/or communicatively couples with a navigation system 306. In some embodiments, the UAV includes one or more coordination navigation sensors 308 or sensor systems communicatively coupled with the UAV control circuit. Further, the UAV typically includes one or more other different sensors and/or sensor systems, such as but not limited to one or more: altimeter sensors, inertial sensors, global positioning systems (GPS), velocity sensor systems, gyroscope systems, distance sensors (e.g., optical and/or acoustic), and other such sensor systems. The UAV control circuit may include and/or couple with one or more transceivers 312 that provide wireless and/or wired communication. Additionally, the UAV 102 includes a retail product carrying system 314 that is configured to support one or more products 301 to be transported by the UAV. In some embodiments, the product carrying system may include and/or couple with a product lowering system 316 that can lower the one or more products (e.g., a crane system that can spool out a cable from which the product is suspended and can be lowered or raised. This allows the UAV to maintain a desired altitude while lowering the one or more products to a target location (e.g., a mobile control point 104).

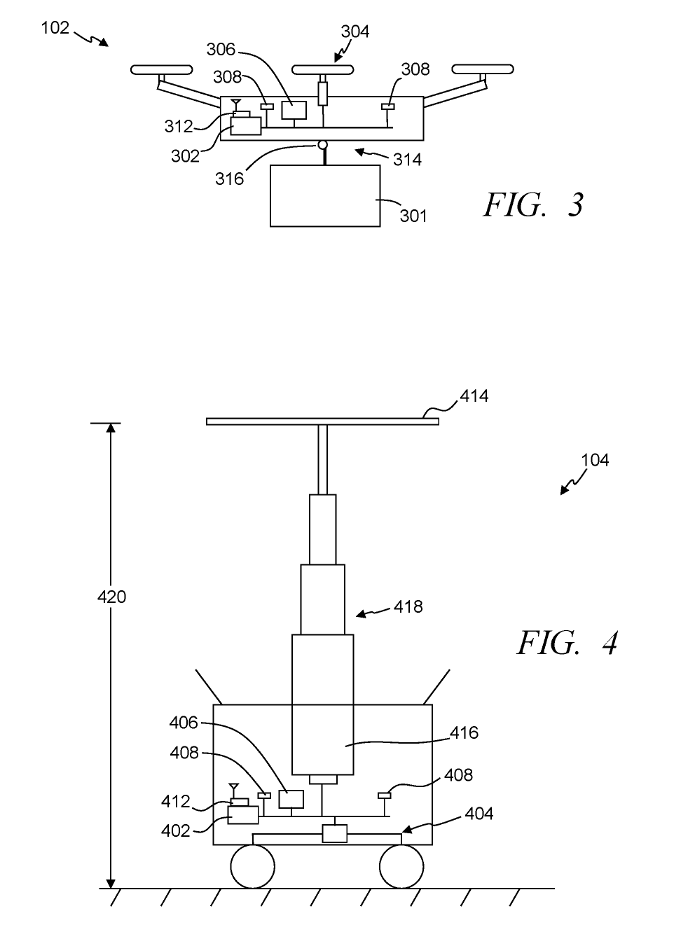

FIG. 4 illustrates a simplified block diagram of an exemplary mobile control point 104, in accordance with some embodiments. The mobile control point 104 includes one or more MCP control circuits 402 and one or more ground based transport systems 404 that includes one or more motors cooperated with wheels, tank treads, and the like that enabling the mobile control point to travel along the ground in intended directions. The MCP control circuit 402 includes and/or communicatively couples with a navigation system 406. In some embodiments, the mobile control point include one or more inbound navigation sensors 408 or sensor systems communicatively coupled with the MCP control circuit. Further, the mobile control point typically includes one or more other different sensors and/or sensor systems, such as but not limited to one or more: inertial sensors, global positioning systems (GPS), velocity sensor systems, gyroscope systems, distance sensors (e.g., optical and/or acoustic), odometer, and other such sensor systems. The MCP control circuit may include and/or couple with one or more transceivers 412 that provide wireless and/or wired communication.

The mobile control point 104 further includes one or more product receiving platforms 414, baskets, end effectors, and/or other such receiving systems that are positioned and configured to receive one or more products intended to be delivered. In some instances, the product receiving platform 414 enables a UAV to land on the platform and release the one or more products. In other implementations, the product receiving platform 414 includes a recess, walls, sloping sides and/or other such structure that may aid in the product being received into and/or onto the product receiving platform, and/or to help in keeping the one or more products from falling at least while being transported by the mobile control point. The product receiving platform, in some applications may further expand and retract, fold and unfold and/or include other such structure features to allow a surface area of the product receiving platform to be increased and decreased. Further, in some embodiments, the mobile control point includes a receiving platform extending system 416 that can extend one or more of the product receiving platforms 414 to be more easily accessed by the UAVs and/or to provide added security and safety. The platform extending system 416 can include one or more motors, hydraulics, gears, pulleys, cables and/or other such mechanisms cooperated with a telescoping support 418, one or more arms, scissor hinged travels or arms, and the like that enable the mobile control point to raise and lower (and in some instances move left and right relative to a body and/or housing of the mobile control point) the product receiving platform 414. In other embodiments, the mobile control point may be configured with non-adjustable height that is at a desired height to provide at least some safety to the products and UAVs.

The product receiving platform 414 and/or platform extending system 416 may further enable the platform to be tilted, a trap door may be included, the MCP may include a retrieving arm, a conveyor system, and the like configured to cause the product to be transferred from the mobile control point 104 and placed at the delivery location. The mobile control point may further include one or more product identifier systems (e.g., barcode scanner, RFID tag reader, camera and processing system, optical character recognition (OCR) system, etc.). The product identifier system can couple with the MCP control circuit to provide product identifier data used by the MCP control circuit to identify products received, confirm the products are those expected, and selectively deliver the appropriate one or more of the products to the intended one or more delivery locations.

In some embodiments, the mobile control point may further include a product carrying locker or cavity. The product may be deposited into the carrying locker while the product is transported to the intended delivery location. The carrying locker can be locked and discourage theft and other mischief. In some instances, the carrying locker may include a climate controlled system that can be activated when the product is to be maintained relative to one or more threshold temperatures. Further, mobile control point can include a product removal system, which can be cooperated with the carrying locker when a carrying locker is included. The product removal system can include one or more conveyor systems, tilt systems, doors, end effectors, robotic arms, and/or other such systems that can move the product from the mobile control point and deposit the product at the delivery location.

Referring to FIGS. 1-4, the aerial retail product delivery system 100 utilizes the plurality of UAVs 102 to transport products to pre-selected intermediate locations 210 when the UAVs cannot otherwise complete the delivery because of one or more obstacles 208, 209, and the plurality of mobile control points 104 to receive and complete the product deliveries. In some embodiments, the central control system 106 and/or the delivery control system 114 identify that a particular delivery location 204 cannot receive deliveries directly from an aerial vehicle. This identification may be based on a UAV traveling toward the location and detecting one or more obstacles in route (e.g., one or more no-fly-zones that prevent the UAV from getting to the delivery location); a UAV traveling to or proximate the delivery location and detecting one or more obstacles at or near the delivery location 208 that temporarily or permanently hinder or prevent the UAV from making the delivery or make the delivery within safety margins; historic data from previous UAVs and/or persons making or attempting to make deliveries at the location or near the location (e.g., attempted deliveries at a neighbor's house, across a street, across a parking lot, etc.); notifications from customers requesting the delivery; notifications from mobile control systems operating in the area; other such factors; or a combination of two or more of such factors.

The plurality of unmanned mobile control points 104 are each configured to move to one or more of a plurality of the different pre-selected intermediate locations 210. Again, the intermediate locations are a distance from and separate from the obstructed intended delivery locations 208, but are selected to be proximate to and/or within threshold distances of one or more intended delivery locations 208. A mobile control point 104 can position itself at the intermediate location 210 and receive one or more products intended for delivery at one or more obstructed delivery locations 208. It is noted that the mobile control point may further receive products intended for delivery at non-obstructed delivery locations when it is determined that it would be more efficient to have the mobile control point make such deliveries, such as but not limited to when a non-obstructed delivery location is along a route that the mobile control point is predicted to travel in making a delivery to an obstructed delivery location and the same UAV is carrying products for both the non-obstructed and the obstructed location, the non-obstructed location is within a threshold distance of the obstructed delivery location 208, and/or other such conditions.

In some embodiments, a mobile control point 104 is identified by the delivery control system 114 and directed to move to a previously selected intermediate location 210. Typically, the intermediate location is evaluated in advance to confirm that the UAV can fly to that preselected intermediate location and be able to accurately deposit the one or more products at the location, and that the selected intermediate location is accessible by one or more mobile control points 104. In some embodiments, the intermediate locations are selected to be within threshold distances of one or more docking and/or housing stations 212, which can be configured to allow at least a mobile control point 104 to temporarily dock with the station and at least partially recharge an on-board power source (e.g., rechargeable battery). In some applications, the docking station 212 may further be a storage location for one or more mobile control points 102, allowing the mobile control points to return to the docking station when not in use and remain out in the field for extended periods of time to service one or more delivery areas.

Further, one or more mobile control points 104 can be configured to provide information used to select an intermediate location 210, and in some embodiments the mobile control point selects the intermediate location. The mobile control point may utilize sensors, cameras and other on-board systems to capture relevant information used to evaluate a location in determining whether the location is viable for an intermediate location 210. This information can include one or more factors such as but not limited to one or more of: having a threshold area being vertically open to the sky (which is typically dependent on the UAVs expected to be utilizing the intermediate location and their control accuracy), having a threshold open area around the location, being out of a road, having access rights (e.g., not on someone's property, or on a property that has granted access), being within a threshold distance of a docking station 212, being within a threshold distance of a particular intended delivery location, being within a threshold distance of a set of potential delivery locations and/or a threshold quantity of potential delivery locations, and/or other such factors.

The UAV control circuits 302 of the plurality of UAVs 102 implement code to control the transport system 304 to implement navigation as defined by the delivery route and navigation instructions from the navigation system 306. The navigation controls of the UAV are determined based on navigation sensor data received from the one or more navigation sensors 308. Further, the navigation system may direct modifications to a delivery route based on sensor data (e.g., detected air traffic, detected temporary or permanent no-fly-zone, obstacle, etc.).

Additionally, the UAVs 102 and the mobile control points 104 are further configured to cooperatively operate to align the UAV and the mobile control point and implement the transfer of the one or more products between a UAV and a mobile control point. In some embodiments, the UAV control circuit 302 implements code to apply a set of one or more alignment rules to determine adjustments of flight path of the UAV and to a final approach path between the UAV 102 and a mobile control point 104 to improve an alignment approach between the UAV and the mobile control point that is at a pre-selected intermediate location 210 that is associated with the mobile control point (e.g., within a delivery area in which the mobile control point is allocated, within a threshold distance of a docking station 212, within a threshold distance of a current location of a mobile control point, the mobile control point is the closest mobile control point available at a transfer time, and the like). The final approach path corresponds to a final portion of the flight path of the UAV 102 to put the UAV within a position to accurately transfer the one or more products to the mobile control point 104. The final approach path includes minor adjustments to ensure alignment and/or optimal approach along at least the final few meters or tens of meters between the UAV 102 and the mobile control point 104. Further, the final approach path may be limited to that portion of the flight path while the UAV 102 can detect the mobile control point through one or more cameras, optical beacon, and thus providing effectively line-of-sight. In some applications, the final approach path includes precision flight adjustments during the portion of the flight path that are not defined by the general delivery route or flight plan of the UAV, and is implemented based sensor inputs to affect the UAVs approach and cooperation with the mobile control point 104.

The adjustments of the final approach path is implemented, at least in part, by the UAV control circuit 302 applying cooperative navigation between the UAV 102 and the mobile control point 104 as a function of both a set of navigation data detected by at least the coordination navigation sensor 308 of the UAV 102 that corresponds to the alignment approach between the UAV and the mobile control point, and a set of navigation data detected by at least the inbound navigation sensor 408 of the mobile control point 104 as the UAV approaches the mobile control point. The coordination navigation system may be one or more optical beacon signal sensors, one or more distance measurement sensors, one or more optical alignment sensors (e.g., photodetectors, etc.) detecting one or more lasers or other light emitted by the mobile control point, one or more acoustic sensors, GPS system, gyroscope systems, accelerometers, one or more cameras and image processing systems, other such sensor systems, or combination of two or more of such sensor systems. The sensor data obtained is used by the UAV control circuit to determine alignment with the mobile control point.

The inbound navigation sensor 408 can similarly include one or more optical beacon signal sensors, one or more distance measurement sensors, one or more optical alignment sensors (e.g., photodetectors, etc.) detecting one or more lasers or other light emitted by the mobile control point, one or more acoustic sensors, GPS system, gyroscope systems, accelerometers, one or more cameras and image processing systems, other such sensor systems, or combination of two or more of such sensor systems. Some or all of the sensor data detected by one or more of the inbound navigation sensors 408 can be communicated to the UAV through wireless communication, and/or processed at the mobile control point 104 with the mobile control point determining desired adjustments in alignment of the UAV. Further, in some embodiments, the MCP control circuit 402 uses the sensor data to determine a location and/or orientation of the UAV relative historic sensor data associated with previous UAV approaches to the same and/or other mobile control points 140 while at the current preselected intermediate location 210. Still further, the historic sensor data and/or historic alignments between the UAV and the mobile control point determined based on the historic sensor data can be rated based on previous final approach paths. For example, the ratings may correspond to numbers of adjustments that were made to achieve a final alignment (e.g., with greater numbers of adjustments having a reduced rating), time to achieve a final alignment (e.g., with longer times having reduced ratings), the variations in adjustments (e.g., with greater variations having reduced ratings), and/or other such factors. The ratings may further take into consideration other conditions (e.g., wind speed, size and/or weight of product being transferred, etc.). Further, the historic data may be used to identify one or more preferred or optimal paths (e.g., avoiding potential obstacles, limiting exposure to traffic, reducing visibility to drivers and/or pedestrians, and/or other such preferred paths). For example, based on historic approaches between UAVs and mobile control points at the pre-selected intermediate location 210, it may be identified that approaching from a particular direction provides reduced numbers of adjustments because of less obstacles and/or typical wind patterns, and such information can be used to provide adjustment and/or sensor data to the UAV for use in adjusting the flight of the UAV in adjusting the final approach path. Accordingly, the UAV control circuit 302 can receive sensor data and/or navigation instructions from the mobile control point 104, and apply adjustment rules to determine adjustments to the final approach path of the UAV based on input from both the UAV 102 and the separate mobile control point 104.

In some embodiments, MCP control circuit 402 applies one or more MCP adjustment rules utilizing the set of navigation data detected by the inbound navigation sensors 408 to determine, as the UAV approaches the MCP, one or more MCP adjustment instructions to be implemented by the UAV that the MCP control circuit determines would improve alignment. These MCP adjustment instructions may be based on a determined misalignment, a correlation between the navigation data and historic adjustments that were subsequently identified as beneficial, and/or other such factors. The MCP control circuit can direct the wireless communication of the one or more MCP adjustment instructions to the UAV. The UAV control circuit 302 receives the one or more MCP adjustment instructions directly from the MCP control circuit 402. In some embodiments, the MCP control circuit 402 applies one or more adjustment rules to identify a relative location of the UAV relative to the product receiving platform 414, and accesses an adjustment database that includes associations between previous UAV locations relative to the current location of the product receiving platform and previous advantageously implemented adjustments to previous final approach paths. Based at least in part on a determine difference between a current alignment and/or positioning of the UAV 102 relative to the current location of the mobile control point 104 and/or product receiving platform, the MCP control circuit identifies the MCP adjustment instructions from the adjustment database based on the relative location of the UAV. Accordingly, in some implementations, the UAV control circuit in determining the adjustments to the final approach path can select the MCP adjustments instructions and implement those MCP adjustment instructions.

The UAV control circuit 102 can control the transport system 304 and implement the adjustments to flight of the UAV to modify the final approach path. In some instances, one or more MCP adjustment instructions may include a priority value or rating, which can be considered by the UAV control circuit, giving higher ratings greater consideration and more likely to be implemented when such adjustments do not conflict with one or more safety parameters applied by the UAV control circuit. The rating can be defined by the MCP control circuit based on historic results achieved in response to implementing the adjustments, historic problems and/or misalignments encountered based on not implementing the adjustment, and/or other such information.

Additionally or alternatively, some or all of the navigation data detected by the inbound navigation sensors 408 can be wirelessly communicated from the mobile control point 104 to the UAV 102, and the UAV control circuit can utilize some or all of the received navigation data detected by the navigation sensors in evaluating and adjusting the final approach path. Some of the navigation data detected by the inbound navigation sensors 408 may be used as it is received, while other navigation data detected by the inbound navigation sensors may be processed. The processing may be to compare navigation data from the mobile control point 104 with navigation data detected by the coordination navigation sensors 308 of the UAV 102, a difference may be determined and utilized, an average may be determined and utilized, one may override the other, and/or other such processing. In some embodiments, the UAV control circuit 302 receive, wirelessly via the transceiver 312 and directly from the mobile control point 104, the set of navigation data detected by the inbound navigation sensors 408 of the mobile control point 104 as the UAV 102 approaches the mobile control point. The received navigation data can be used and/or processed. For example, navigation data corresponding to one or more inbound navigation sensors 408 may be compared to corresponding navigation data of the set of navigation data from a corresponding coordination navigation sensors 308 of the UAV 102, an average may be determined, a standard deviation may be determined, and average over a period of time may be determined, a summation may be determined, and/or other such processing. Using the data, the UAV control circuit can determine adjustments to a final approach path based on, for example, a difference between the set of navigation data from one or more of the coordination navigation sensors 308 with the set of navigation data from one or more of the inbound navigation sensors 408.

Further, in some embodiments, the UAV control circuit can communicate some or all of the navigation data detected by the inbound navigation sensors to the mobile control point 104. The MCP control circuit 402 is configured to apply a rule set of one or more rules in evaluating the navigation data and implement one or more location adjustments to the product receiving platform 414 to achieve a cooperative alignment. The adjustments may be raising or lowering the platform, shifting the platform and/or the mobile control point 102 left, right, forward, backward, and/or other such adjustments.

The UAV control circuit 302 is further configured to direct the transfer of one or more products from the retail product carrying system 314 of the UAV to the product receiving platform 414 of the mobile control point 104 to cause the mobile control point to transport to and deposit at least one product at the intended delivery location that is separate and distant from the pre-selected intermediate location. Cooperative adjustments in positioning of the UAV relative to the mobile control point, and/or the mobile control point relative to the UAV can be implemented through the cooperative sharing of navigation sensor data between the UAV and the mobile control point while the one or more products are transferred. In some embodiments, the transfer includes the UAV landing on the product receiving platform 414 and activating one or more release mechanisms (e.g., electromagnets, doors, hooks, latches, pins, crane systems, ramps, etc.) to release the product from the UAV. For example, in some implementations the UAV 102 may include a lowering system 316 (e.g., a spool of rope or cable, crane system, etc.) that can lower the product while the UAV hovers above the mobile control point 104. In some embodiments, the UAV control circuit can communicate a request that the mobile control point complete the delivery, instructions and/or routing information may be communicated to the mobile control point by the UAV 102, the central control system 106 and/or the delivery control system 114. When communicated by the UAV 102, the UAV may receive such information from the central control system, the delivery control system or another source.

The transfer of the product, in some embodiments, is preceded by the positioning of the product receiving platform 414. In some implementations, the MCP control circuit 402 may receive confirmation from the UAV 102 of the intended transfer of the product from the UAV to the mobile control point, and can control the receiving platform extending system 416 to extend the product receiving platform to a predefined height 420, which is typically at a height that is generally inaccessible to pets, people and livestock in preparation for receiving the product from the UAV. Similarly, the mobile control point may receive instructions from the delivery control system 114, the central control system 106, and/or other system directing the mobile control point to the intended intermediate location 210 and to extend the product receiving platform 414.

The UAV control circuit 302, in some embodiments, is further configured to receive authentication data from the mobile control point 104 prior to transferring the one or more products to the mobile control point, and in some instances prior to initiating the final approach path. The authentication data may include a password received from the central control system 106 or delivery control system 114, a product identifier of the product to be transferred, a unique identifier of the mobile control point (e.g., alphabetic and/or numeric identifier), a unique identifier of the UAV 102, a predefined encryption key, a block chain confirmation, other such authentication data or a combination of two or more of such authentication data. The UAV control circuit can utilize the received authentication data and confirm an authentication of the mobile control point 104 as a prerequisite to initiating an alignment with the mobile control point, a prerequisite to at least directing the transfer of the product from the retail product carrying system 314 to the product receiving platform 414 of the mobile control point 104, and/or other such actions. Accordingly, the UAV 102 can confirm the correct mobile control point 104 is receiving the product and/or that the correct product is being transferred. The confirmation further avoids transferring the product to a rogue mobile control point, can be used as part of a confirmation of the delivery process, and the like.

In some embodiments, the delivery control system 114 and/or the central control system coordinate a particular mobile control point 104 to complete a delivery of a particular product for a UAV 102. In other instances, however, a mobile control point is not pre-assigned. Similarly, in some instances, a previously assigned mobile control point may be delayed, may have a problem (e.g., battery level dropping below a threshold, damage, etc.), and accordingly, a UAV may approach a delivery area when a mobile control point has not been assigned to complete the delivery. In some embodiments, the UAV 102 is configured to dynamic cooperate with a mobile control point. A UAV control circuit 302 can cause one or more wireless transceivers to wirelessly broadcast a request to implement a product transfer of at least one product with one or more mobile control points 104 that are each within a threshold distance of the intended delivery location of the product and/or within a threshold distance of at least one of a set of one or more intermediate locations 210 that are within a threshold distance of the intended delivery location. Typically, one or more responses are wirelessly received at the UAV 102 from one or more mobile control points 104. The responses may include parameters and/or factors information that can be used by the UAV control circuit 302 in selecting a mobile control point to complete the delivery. For example, the factors may specify a current location of the mobile control point 104, a distance from an intermediate location 210, capabilities of the mobile control point (e.g., carrying weight capacity, carrying dimensions capacity, distance to travel capacity, one or more levels of security that can be implemented by the mobile control point, whether the mobile control point has the ability to confirm a customer's identity, whether the mobile control point can receive payment, and/or other such factors). The UAV 102 can select a mobile control point from the multiple mobile control points (when multiple control points respond) based on at least the responses to the broadcast received from the one or more mobile control points. For example, the UAV control circuit 302 may consider the factors provided by the one or more mobile control points such as, but not limited to, battery level, distance from an intermediate location 210, distance from an intended delivery location 204, capabilities of the mobile control point, a duration of availability of the mobile control point, and the like. The factors may be evaluated relative to one or more thresholds, and/or compared to corresponding factors reported by the other available mobile control points (e.g., the UAV control circuit 302 may also consider such factors relative to corresponding factors of other mobile control points and select the mobile control point with the best available factors (e.g., battery level may not be above a threshold, but has the greatest level of those available mobile control points)). By broadcasting, the 100 the delivery system 100 can dynamically allocate mobile control points 104 on an as needed basis. This broadcasting can be utilized instead of pre-assigning a mobile control point, or can be used in cooperation with pre-assigning at least some mobile control points. For example, when a pre-assigned mobile control point continues to be engaged in another delivery, has been delayed, is experiencing a malfunction and/or other such conditions, the system can dynamically allocate another mobile control point, which may include the use of the broadcast from the UAV 102.

As introduced above, the UAV control circuit 302, the central control system 106, and/or the delivery control system 114 can further consider the capabilities of mobile control points in selecting a mobile control point to complete a delivery. The capabilities may be specified in one or more databases, and/or communicated by the mobile control points. In some embodiments, a UAV control circuit 302 may obtain MCP capability data of one or more mobile control points 104. The capabilities may be received from mobile control points in the responses to the broadcast, obtained from local memory on the UAV, wirelessly requested from the delivery control system 114, and/or obtained from another source. The UAV control circuit can further access product transport parameters corresponding to the one or more products to be delivered. The product transport parameters may specify, for example, a weight of the product, dimensions of the product, summation of weight of multiple products, summation of dimensions of multiple products, delivery locations, a fragile rating, whether temperature control is needed by the mobile control point, whether customer identification confirmation is needed prior to releasing the product to a customer, whether payment is to be received prior to releasing the product to a customer, and/or other such transport parameters. The UAV control circuit 302 can evaluate the received MCP capabilities relative to the transport parameters, and confirm when a mobile control point is capable of receiving the one or more products and implementing the delivery of the one or more products to the intended one or more delivery locations.

Further, in some embodiments it can be beneficial or even critical to coordinate the timing between an arrival of a UAV 102 and the arrival of the mobile control point 104 at an intermediate location 210. This coordinated arrival may be for security reasons, inhibit mischievous activity directed toward the mobile control point and/or the UAV, limit air and/or ground traffic, reduce delays, account for limits in battery power, and/or other such factors. In some embodiments, the MCP control circuit 402 implementing code is configured to receive a UAV arrival time. This arrival time maybe received from the delivery control system 114, the UAV 102, relayed from another device (e.g., another mobile control point 104, docking station 212, etc.), or received from another source. In some embodiments, the arrival time is estimated by the delivery control system 114 based on expected flight duration from a flight departure location and a departure time of the UAV. In some implementations, the delivery control system may receive updated information from the UAV 102, such as GPS data and corresponding timing, and allowing the delivery control system to update an estimated arrival time at the intermediate location 210. The MCP control circuit 402 can apply one or more estimation rules relative to a current location and the intermediate location 210 to determine an estimated travel time to the pre-selected intermediate location 210.

In some embodiments, the rules direct the MCP further access historic travel times relative to one or more portions of a route the mobile control point is expected to travel in reaching the intermediate location 210. Other factors may be considered, such as but not limited to battery levels of the mobile control point, current traffic conditions, historic traffic patterns, other deliveries for which the mobile control point is scheduled to implement, and/or other such factors. Using this information the MCP control circuit 402 can estimate the travel time from a current location or a future location (e.g., a delivery location of a scheduled delivery to be implemented by the mobile control point 104 prior to meeting the UAV, the location of a docking station 104 at which the mobile control point is expected to be prior to initiating movement to the pre-selected intermediate location 210, etc.). The MCP control circuit 402 can track time and activate the transport system 404 to arrive at the pre-selected intermediate location 210 within a threshold period of time prior to or after the UAV arrival time. The threshold period may be dependent on a time of arrival (e.g., threshold being reduced during night time and/or during busy times, while being longer when not busy times, during the day, etc.), type of product and/or value of the product to be transported, the security of the pre-selected intermediate location (e.g., based on historic incidents, police reports, reports from customers with a threshold distance, etc.), weather conditions (e.g., increased when it is snowing, raining, threshold levels of wind, snow on the ground, etc.), and/or other such factors. In some embodiments, each mobile control point 104 can be equipped with a unique beacon, unique encoded identifier encoded into a beacon signal, a different color pattern, uses a predefined radio frequency, or the like, which can be used by the UAV 102 in distinguishing between mobile control points and in approaching the relevant mobile control point. This way the UAV can distinguish and identify the mobile control point that is to receive the package. Similarly, the UAVs can utilize unique beacon signals, unique encoded identifier encoded into a beacon signal, a different color pattern, uses a predefined radio frequency, or the like, that allow mobile control points to distinguish and/or identify a UAV.

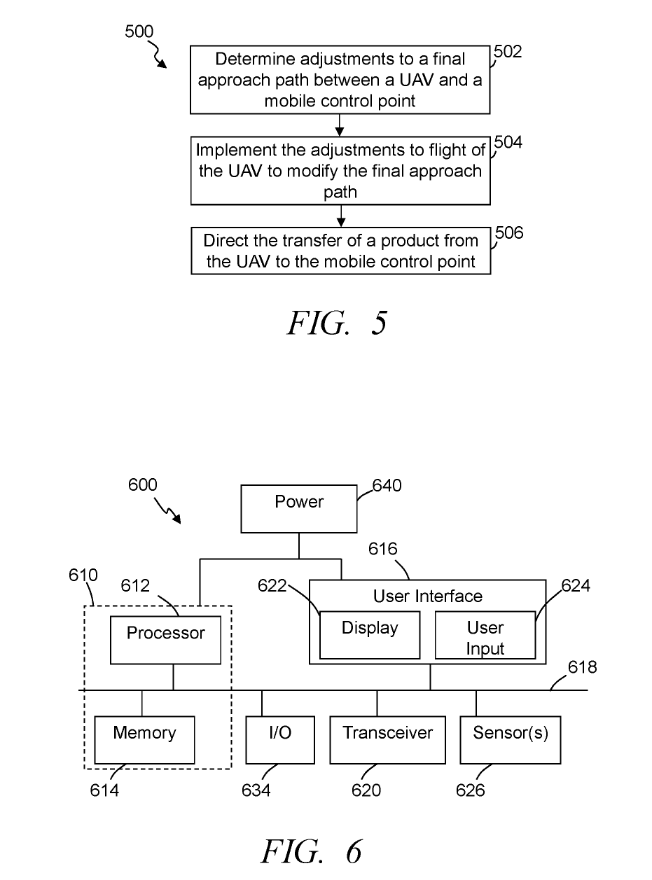

FIG. 5 illustrates a simplified flow diagram of an exemplary process 500 of providing aerial retail product delivery through a cooperation of mobile devices, in accordance with some embodiments. In step 502, a UAV control circuit 302 determines adjustments to a final approach path between the UAV 102 and an unmanned ground vehicle mobile control point 104 of plurality of mobile control points. The plurality of mobile control points, which are each configured to move to one or more pre-selected intermediate locations are proximate to but distant from intended delivery locations of the one or more respective retail products carried by a corresponding one of a plurality of UAVs 102 to complete the delivery to the respective delivery location. As described above, the adjustments to the final approach path are to improve the alignment approach between the UAV 102 and the mobile control point 104 by applying a cooperative navigation between the UAV and the mobile control point as a function of both a set of navigation data detected by one or more coordination navigation sensors 308 of the UAV 102 and that corresponds to an alignment approach between the UAV and the mobile control point, and a set of navigation data detected by one or more inbound navigation sensors 408 of the mobile control point 104 as the UAV 102 approaches the mobile control point.

In step 504, the adjustments to flight of the UAV to modify the final approach path are implemented. In step 506, a transfer of one or more products is directed from a retail product carrying system 314 of the UAV 102 to one or more product receiving platforms 414 of the mobile control point 104 to cause the mobile control point 104 to transport to and deposit the one or more products at one or more intended delivery locations that are separate and distant from the pre-selected intermediate location 210 associated with the mobile control point.

In some embodiments, the UAV 102 wirelessly receives, directly from the mobile control point 104, MCP adjustment instructions from the MCP control circuit 404 based on the set of navigation data detected by the one or more inbound navigation sensors 408 of the mobile control point as the UAV 102 approaches the mobile control point. In determining the adjustments to the final approach path, some embodiments select the MCP adjustments instructions, and the UAV control circuit 302 implements the MCP adjustments. The MCP control circuit 402 may further identify a relative location of the UAV relative to the product receiving platform 414 of the mobile control point. An adjustment database may be accessed that comprises associations between previous UAV locations relative to a product receiving platform and previous advantageously implemented adjustments to previous final approach paths. The MCP adjustment instructions may be identified from the adjustment database based on the relative location of the UAV.

The MCP control circuit 402 may further receive confirmation of the intended transfer of the product from the UAV 102 to the mobile control point 104, and can control the receiving platform extending system 416 of the mobile control circuit to extend the product receiving platform 114 to a predefined height 420 in preparation for receiving the product from the UAV 102. In some applications, the predefined height is selected to that the product is typically inaccessible to pets, people and livestock that may interfere in the transfer of the one or more products. The UAV control circuit 302 may further request and/or receive authentication data from the mobile control point at least prior to initiating the transfer, and in some instances prior to initiating the final approach. An authentication of the mobile control point can be confirmed as a prerequisite to directing the transfer of the product from the retail product carrying system 314 to the product receiving platform 414 of the mobile control point.

In some embodiments, the UAV control circuit 302 wirelessly receives, through the transceiver 312 and directly from the mobile control point 104, the set of navigation data detected by the one or more inbound navigation sensors 408 of the mobile control point as the UAV approaches the mobile control point. The UAV control circuit 302 and/or the central control system 106 can compare the received set of navigation data with the set of navigation data detected by the coordination navigation sensor 308 of the UAV 102 in determining adjustments to the final approach path. In some applications, the adjustments may be based on differences between the sets of navigation data, similarities between the sets of navigation data, averages of one or more of the navigation data, and/or other such determined relationships between the sets of navigation data.

Some embodiments further broadcast a request to implement a product transfer of a product carried by a UAV 102 with one of multiple mobile control points 104 that are each within a threshold distance of the intended delivery location 204. A UAV control circuit may apply a set of one or more selection rules to select a particular mobile control point 104 from the multiple mobile control points. In some embodiments, one or more of the selection rules are applied to parameters received based on at least a response to the broadcast that is received from the mobile control points 104. The rules may direct the selection of the mobile control point closest to the intermediate location 210 that is closest to the intended delivery location. In other instances, a mobile control point is selected that has at least a threshold level of battery power (e.g., threshold set based on an expected power usage to move to the intermediate location, receive the product, transport the product to the intended delivery location and return to a docking station 212), is available at an estimated arrival time of the UAV at the intermediate location and a predicted duration to implement the delivery, and can carry the product (e.g., can support the weight of the product, and can release the product at the intended delivery location). Other rules and/or parameters can be considered in selecting the mobile control point. Further, the rules may direct the UAV control circuit 302 to obtain MCP capability data of one or more mobile control points 104. The MCP capability data may be obtained from responses to the broadcast from the mobile control points, from the delivery control system, from historic data stored on and/or accessed by the UAV control circuit, and/or other such sources. Further, the UAV control circuit accesses product transport parameters corresponding to the one or more products to be transferred. Again, this product transport parameters may be provided by the delivery control system 114, accessed by the UAV control circuit (e.g., one or more remote databases) based on receiving and/or detecting a product identifier (e.g., the UAV may have an RFID tag reader, a barcode scanner, etc.), or other such sources. The UAV control circuit can confirm that a mobile control point 104 is capable of receiving the one or more products and implementing the delivery of the one or more products to the intended one or more delivery locations 204.

Some embodiments further coordinate arrival times between UAVs and mobile control points at selected intermediate locations 210. The MCP control circuit 402 of a mobile control point 104 can receive an expected UAV arrival time, and determine an estimated travel time to a pre-selected intermediate location 210. Based on the estimated travel time and the UAV arrival time, the MCP control circuit can activate the ground based transport system 404 to arrive at a pre-selected intermediate location 210 within a threshold period of time of the UAV arrival time. Alternatively or additionally, the UAV control circuit 302 of a UAV 102 can receive a mobile control point expected arrival time, and determine an estimated travel time to a pre-selected intermediate location 210. Based on the estimated travel time, the UAV control circuit 302 can control the aerial transport system 304 to arrive at the pre-selected intermediate location 210 within a threshold period of time of the mobile control point expected arrival time. Still further, one or both of the UAV and the mobile control point can adjust their rate of travel based on current location and adjusted estimated arrival times of one or both the mobile control point and the UAV.

Further, the circuits, circuitry, systems, devices, processes, methods, techniques, functionality, services, servers, sources and the like described herein may be utilized, implemented and/or run on many different types of devices and/or systems. FIG. 6 illustrates an exemplary system 600 that may be used for implementing any of the components, circuits, circuitry, systems, functionality, apparatuses, processes, or devices of the delivery system 100 and/or other above or below mentioned systems or devices, or parts of such systems, circuits, circuitry, functionality, apparatuses, processes, or devices. For example, the system 600 may be used to implement some or all of the UAVs 102, the mobile control points 104, the central control system 106, the delivery control system 114, the inventory system 116, the product ordering system 118, and/or other such components, circuitry, systems, functionality and/or devices. However, the use of the system 600 or any portion thereof is certainly not required.

By way of example, the system 600 may comprise a control circuit or processor module 612, memory 614, and one or more communication links, paths, buses or the like 618. Some embodiments may include one or more user interfaces 616, and/or one or more internal and/or external power sources or supplies 640. The control circuit 612 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 612 can be part of control circuitry and/or a control system 610, which may be implemented through one or more processors with access to one or more memory 614 that can store instructions, code and the like that is implemented by the control circuit and/or processors to implement intended functionality. In some applications, the control circuit and/or memory may be distributed over a communications network (e.g., LAN, WAN, satellite, Internet) providing distributed and/or redundant processing and functionality. Again, the system 600 may be used to implement one or more of the above or below, or parts of, components, circuits, systems, processes and the like. For example, the system may implement the UAV 102 with the control circuit being a UAV control circuit 302, the mobile control point 104 with the control circuit being a MCP control circuit 402, central control system 106 with the control circuit being a central control circuit, or other components.

The user interface 616 can allow a user to interact with the system 600 and receive information through the system. In some instances, the user interface 616 includes a display 622 and/or one or more user inputs 624, such as buttons, touch screen, track ball, keyboard, mouse, etc., which can be part of or wired or wirelessly coupled with the system 600. Typically, the system 600 further includes one or more communication interfaces, ports, transceivers 620 and the like allowing the system 600 to communicate over a communication bus, a distributed computer and/or communication network 110 (e.g., a local area network (LAN), the Internet, wide area network (WAN), etc.), communication link 618, other networks or communication channels with other devices and/or other such communications or combination of two or more of such communication methods. Further the transceiver 620 can be configured for wired, wireless, optical, fiber optical cable, satellite, or other such communication configurations or combinations of two or more of such communications. Some embodiments include one or more input/output (I/O) ports 634 that allow one or more devices to couple with the system 600. The I/O ports can be substantially any relevant port or combinations of ports, such as but not limited to USB, Ethernet, or other such ports. The I/O interface 634 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 626 to provide information to the system and/or sensor information that is communicated to another component, such as the UAV 102, the mobile control point 104, the central control system 106, the delivery control system 114, the inventory system 116, etc. The sensors can include substantially any relevant sensor, such as distance measurement sensors (e.g., optical units, sound/ultrasound units, etc.), accelerometer, velocity sensor, global positioning (GPS), optical based scanning sensors to sense and read optical patterns (e.g., bar codes), radio frequency identification (RFID) tag reader sensors capable of reading RFID tags in proximity to the sensor, cameras, image and/or video processing, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 600 comprises an example of a control and/or processor-based system with the control circuit 612. Again, the control circuit 612 can be implemented through one or more processors, controllers, central processing units, logic, software and the like. Further, in some implementations the control circuit 612 may provide multiprocessor functionality.

The memory 614, which can be accessed by the control circuit 612, typically includes one or more processor readable and/or computer readable media accessed by at least the control circuit 612, and can include volatile and/or nonvolatile media, such as RAM, ROM, EEPROM, flash memory and/or other memory technology. Further, the memory 614 is shown as internal to the control system 610; however, the memory 614 can be internal, external or a combination of internal and external memory. Similarly, some or all of the memory 614 can be internal, external or a combination of internal and external memory of the control circuit 612. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 110. The memory 614 can store code, software, executables, scripts, data, content, lists, programming, programs, log or history data, user information, customer information, product information, and the like. While FIG. 6 illustrates the various components being coupled together via a bus, it is understood that the various components may actually be coupled to the control circuit and/or one or more other components directly.

The use of UAVs 102 in implementing deliveries can provide better, faster, and less expensive deliveries than many other delivery methods, as well as being more convenient in many instances than a customer simply going to the store. Further, the use of UAVs may be particularly advantageous with relatively short-range routes from a launch point to the delivery location. It has been identified, however, that the use of UAVs can be inhibited by obstacles and other aspects that interfere with a UAV being able to reach a delivery location or delivery the package to the intended delivery location. The present embodiments further utilize unmanned mobile control points 104 to act as an intermediary and receive packages from one or more UAVs. The mobile control points may identify suitable intermediate locations 210 and/or preselected intermediate locations 210 can be supplied to the mobile control points where the mobile control point can receive one or more packages from one or more UAVs 102. The intermediate location 210 is a distance from the intended delivery location, and often is utilized because the UAV cannot access the delivery location and/or the product cannot be delivered to the location using a UAV. In some instances, the intermediate location 210 may be relatively close to the intended delivery location (e.g., tens of feet), while in other instances the intermediate location may be further (e.g., multiple houses away, multiple streets away, thousands of feet or more). The mobile control point 104 receives the one or more packages from the UAV 102 and transports the one or more packages the rest of the distance on the ground to the intended delivery location.

In some embodiments, the delivery control system 114 provides routing information to the mobile control point between a current location of the mobile control point and the intermediate location 210, and/or from the intermediate location to the intended delivery location. Additionally or alternatively, the mobile control point may determine a route based on a current location, mapping information and the location of the intermediate location and/or the intended delivery location. In some embodiments, one or more of the mobile control points 104 are stored in a licensed location (e.g., which may include a docking station 212, housing, kiosk or the like in which the mobile control point docks, recharges and/or is housed while not in use). The storage location of the mobile control point may further be designated as an intermediate location 210 for at least some UAVs 102 and/or intended delivery locations. By providing the cooperation between the UAVs and the mobile control points the delivery system 100 provides fast and efficient delivery, including to locations where a UAV may not be able to delivery.

Further, because the mobile control point is mobile, a single mobile control point can service multiple different delivery locations 204 and in some instances multiple predefined intermediate locations 210. Mobile control points may have several designated intermediate locations suitable for receiving packages and can travel to an optimal intermediate location while a UAV is being dispatched and in flight. The mobile control points provide expanded options to provide delivery for customers that are not registered with a suitable aerial landing spot at the target address or that are otherwise unreachable by aerial delivery. The cooperation between the UAVs and the mobile control points provide can bridge danger zones (e.g., high traffic area between a store and a delivery location door that make direct ground transport from a source location unfeasible), by employing the UAV 102 to fly over the obstacle and transfers the product to the mobile control point at the intermediate location to allow the mobile control point to complete the delivery.

The mobile control point can be owned by the retail entity, the customer, a third party service, a community, or other entity (e.g., a mobile control point can be deployed to roll out to a spot on a driveway that sensors show is clear of obstacles, receive the package at the intermediate location, and then delivery the package (e.g., return to its point of origin)). Further, in some instances, the single mobile control point can serve many customers, such as neighbors, those in an apartment complex, multiple offices, and the like. The intermediate locations provide a predetermined safe transfer location providing a level of safety and security for the UAV, mobile control point and the package. Typically, the intermediate locations 210 stays fixed while the UAVs and mobile control points are mobile to complete the deliveries. Further, in some applications, the mobile control point can elevate the product receiving platform 414 and/or implement other methods to provide at least some isolation for the transfer, and can further provide some protection for the UAV and/or packages from people and animals. One or more docking station 212 can further provide recharging for one or more mobile control points. By using the mobile control points, the intermediate locations can be preselected to avoid product drops and/or transfers at unknown locations.

In some embodiments, the UAV 102 can provide instructions to the mobile control point regarding an intermediate location 210 and/or the delivery location 204. For example, the UAV may provide delivery information to the mobile control point 104 through direct-communication. The delivery information may include, but is not limited to, one or more of: delivery location 204 (e.g., address, map coordinates, longitude and latitude coordinates, and/or other relevant information), product information, special handlings instructions, customer information, unique delivery instructions (e.g., leave it at the door, deliver to the garage, etc.), and/or other such information. In other applications, the delivery control system 114 and/or the central control system 106 may cause some information to be communicated to the mobile control point. The information communicated may assist the mobile control point in preserving temperature thresholds, or any other special handlings or package sensitivities, by sending information on the parameters for the package. For example, for cold chain package transfer a UAV can send instruction on what ambient temperature the mobile control point is to maintain for the package.

The UAV and the mobile control point may employ substantially any relevant direct wireless communication (e.g., RF, Ultra-Wide Band, cellular, satellite, Bluetooth, Wi-Fi, laser communication, etc.). Typically, the UAV 102 authenticates the mobile control point 104 before transferring the package to the mobile control point. In some applications, the authentication is a two-fold process where the UAV authenticates the mobile control point and the mobile control point authenticates the UAV. The authentication may use, for example, Internet Security Protocols, block chain, visual identification (e.g., tail number, serial number, etc.), and other such authentication. Further, some embodiments apply a time-window to coordinate arrival of the UAV and mobile control points at the intermediate location 210. Some embodiments compare a captured image of at least some the intermediate location with a known reference image. The image processing may be performed by the mobile control point, the UAV, a central control system 106 or the like. In some implementations, for example, the UAV 102 captures one or more a visual images of the intermediate location that can be compared with a reference image. Similarly, some embodiments use images as part of an authentication of the mobile control point 104 and/or the UAV by capturing images of the other and comparing to one or more reference images. Further, the UAV and/or the mobile control point may capture images and/or video of the product transfer, which can be used as a confirmation of the transfer.

The UAV and mobile control units communicate to cooperatively adjust the final approach path of the UAV. Further, in some implementations the mobile control point can extend and/or expand a product receiving platform 414 as part of the product transfer. The mobile control point may include a telescoping platform extending system, a scissor extending system, a boom-arm extending system, retractable arm, or other relevant system that can put the product receiving platform in an area that limits or prevents people and animal interference. The UAV may further improve safety by including a product lower system (e.g., crane system, extending arm, scissor system, etc.).

Again, one or both the UAV 102 and the mobile control point 104 may assist the other in final approach navigations. For example, the UAV may use its onboard optics to detect the mobile control point 104 and receive optics from the mobile control point on its position and navigations. The mobile control point and UAV can share real-time information on the other vehicle's location, providing correctional adjustments, as well as the devices location and position. Other sensors can be utilized during the cooperative final approach adjustments and the transfer of the package (e.g., Infrared, ultra-wideband, pixel-based optics, radio frequency, sonar, simultaneous localization and mapping (SLAM), other such sensors, or combination of two or more of such sensors). The assistance between the UAV and the mobile control point provides an extra layer of redundancy and an additional level of accuracy. The UAV is provided additional awareness from the mobile control point. Similarly, the UAV may provide sensor and/or adjustment data to the mobile control point that can be used in adjusting a location of the product receiving platform. The dual cooperation enhances alignment and allows one or both the UAV and the mobile control point to make adjustments relative to the alignment.

In some embodiments, a UAV 102 can wirelessly broadcast a request to transfer a package to a mobile control point that is available, and typically within a threshold distance of one or more preselected intermediate locations 210. A UAV may be approaching and/or roaming in a delivery area 200, and can search for a mobile control point 104 to receive one or more packages and complete the delivery of the one or more packages. In some implementations, a broadcast message includes information regarding the delivery (e.g., delivery address, intended time for transfer, package specifics (size, weight, special handlings, etc.)), which can be used by mobile control points in determining whether it is available (e.g., may be pre-scheduled for a transfer, may have insufficient power levels, may be a threshold distance too far from the delivery location and/or the intermediate location, etc.). One or more mobile control points 104 may wirelessly respond to the broadcast request (e.g., a similar wireless broadcast, a directed communication, etc.). The response may authenticate the mobile control point and/or authenticate the mobile control point's authorization to accept and complete a delivery. Similarly, the UAV can authenticate the mobile control point and/or communicate similar authentication information to the mobile control point. The mobile control point may additionally or alternatively communicate specifications and/or capabilities of the mobile control point to allow the UAV, the delivery control system 114, and/or the central control system 106 to confirm that the mobile control point is capable of successfully completing the delivery process. In some embodiments, the UAV and/or the delivery control system communicates information regarding the intermediate location 210, and/or the mobile control point can transmit information on regarding an intermediate location. The mobile control point and/or the UAV may transmit their current locations, allowing the UAV and/or mobile control point to select a relevant intermediate location 210 and/or to navigate to the other's position. When a mobile control point 104 is not suited for the transfer or delivery, the UAV can reject the transfer and seek an alternative mobile control point.

In some embodiments, systems and methods are provided to enable aerial delivery of products. Some embodiments provide aerial retail product delivery systems, comprising: a plurality of unmanned aerial vehicles (UAV) each comprising a UAV control circuit, a coordination navigation sensor, and a retail product carrying system; a plurality of unmanned ground vehicle (UGV) mobile control points (MCP) each configured to move to a different pre-selected intermediate location that is proximate to but distant from intended delivery locations to complete the delivery to the respective delivery location, wherein each of the MCPs further comprises an MCP control circuit, a product receiving platform, a ground based transport system, and an inbound navigation sensor; wherein a first UAV control circuit of a first UAV of the plurality of UAVs is configured to: determine adjustments to a final approach path between the first UAV and a first MCP to improve an alignment approach between the first UAV and the first MCP at a first pre-selected intermediate location associated with the first MCP by applying a cooperative navigation between the first UAV and the first MCP as a function of both a first set of navigation data detected by the first coordination navigation sensor of the first UAV and that corresponds to the alignment approach between the first UAV and the first MCP, and a second set of navigation data detected by a first inbound navigation sensor of the first MCP as the first UAV approaches the first MCP; implement the adjustments to flight of the first UAV to modify the final approach path; and direct the transfer of a first product from a first retail product carrying system of the first UAV to a first product receiving platform of the first MCP to cause the first MCP to transport to and deposit the first product at a first delivery location that is separate and distant from the first pre-selected intermediate location.

Further, some embodiments, provide methods of providing aerial retail product delivery through a cooperation of mobile devices, comprising: determining, through a first UAV control circuit of a first unmanned aerial vehicle (UAV) of a plurality of UAVs, adjustments to a final approach path between the first UAV and a first unmanned ground vehicle mobile control point (MCP) of a plurality of MCPs, which are each configured to move to a pre-selected intermediate location that is proximate to but distant from intended delivery locations of the one or more respective retail products carried by a corresponding one of the plurality of UAVs to complete the delivery to the respective delivery location, wherein the adjustments to the final approach path are to improve the alignment approach between the first UAV and the first MCP by applying a cooperative navigation between the first UAV and the first MCP as a function of both a first set of navigation data detected by a first coordination navigation sensor of the first UAV and that corresponds to an alignment approach between the first UAV and a first MCP of the plurality of MCPs, and a second set of navigation data detected by a first inbound navigation sensor of the first MCP as the first UAV approaches the first MCP; implementing the adjustments to flight of the first UAV to modify the final approach path; and directing the transfer of a first product from a first retail product carrying system of the first UAV to a first product receiving platform of the first MCP to cause the first MCP to transport to and deposit the first product at a first delivery location that is separate and distant from a first pre-selected intermediate location associated with the first MCP.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. An aerial retail product delivery system, comprising:
a plurality of unmanned aerial vehicles (UAV) each comprising a UAV control circuit, a coordination navigation sensor, and a retail product carrying system;
a plurality of unmanned ground vehicle (UGV) mobile control points (MCP) each configured to move to a different pre-selected intermediate location that is proximate to but distant from intended delivery locations to complete the delivery to the respective delivery location, wherein each of the MCPs further comprises an MCP control circuit, a product receiving platform, a ground based transport system, and an inbound navigation sensor;
wherein a first UAV control circuit of a first UAV of the plurality of UAVs is configured to:
determine adjustments to a final approach path between the first UAV and a first MCP to improve an alignment approach between the first UAV and the first MCP at a first pre-selected intermediate location associated with the first MCP by applying a cooperative navigation between the first UAV and the first MCP as a function of both a first set of navigation data detected by the first coordination navigation sensor of the first UAV and that corresponds to the alignment approach between the first UAV and the first MCP, and a second set of navigation data detected by a first inbound navigation sensor of the first MCP as the first UAV approaches the first MCP;
implement the adjustments to flight of the first UAV to modify the final approach path; and
direct the transfer of a first product from a first retail product carrying system of the first UAV to a first product receiving platform of the first MCP to cause the first MCP to transport to and deposit the first product at a first delivery location that is separate and distant from the first pre-selected intermediate location.

2. The system of claim 1, wherein the UAV control circuit is further configured to wirelessly receive, directly from the first MCP, MCP adjustment instructions from a first MCP control circuit of the first MCP based on the second set of navigation data detected by the first inbound navigation sensor of the first MCP as the first UAV approaches the first MCP; and
in determining the adjustments to the final approach path the UAV control circuit selects the MCP adjustments instructions.

3. The system of claim 2, wherein the first MCP control circuit of the first MCP is configured to identify a relative location of the first UAV relative to the first product receiving platform, accesses an adjustment database that comprises associations between previous UAV locations relative to the first product receiving platform and previous advantageously implemented adjustments to previous final approach paths, and identifies the MCP adjustment instructions from the adjustment database based on the relative location of the first UAV.

4. The system of claim 2, wherein the first MCP control circuit is communicatively coupled with a receiving platform extending system, wherein the first MCP control circuit is configured to receive confirmation of the intended transfer of the first product from the first UAV to the first MCP, and to control the receiving platform extending system to extend the first product receiving platform to a predefined height that is inaccessible to pets, people and livestock in preparation for receiving the first product from the first UAV.

5. The system of claim 2, wherein the first UAV control circuit is configured to receive authentication data from the first MCP, and confirm an authentication of the first MCP as a prerequisite to directing the transfer of the first product from the first retail product carrying system to the first product receiving platform of the first MCP.

6. The system of claim 1, wherein the UAV control circuit is further configured to wirelessly receive, directly from the first MCP, the second set of navigation data detected by the first inbound navigation sensor of the first MCP as the first UAV approaches the first MCP, compares the first set of navigation data with the second set of navigation data, and determine adjustments to a final approach path based on a difference between the first set of navigation data with the second set of navigation data.

7. The system of claim 1, wherein the first UAV control circuit is further configured to broadcast a request to implement a product transfer of the first product with one of multiple of the plurality of MCPs that are each within a threshold distance of the first delivery location, and select the first MCP from the multiple MCPs based on at least a response to the broadcast received from the first MCP.

8. The system of claim 7, wherein the first UAV control circuit is configured to obtain MCP capability data from the response to the broadcast from the first MCP, access product transport parameters corresponding to the first product, and confirm the first MCP is capable of receiving the first product and implementing the delivery of the first product to the first delivery location.

9. The system of claim 1, wherein the first MCP comprises a first MCP control circuit configured to receive a UAV arrival time, determine an estimated travel time to the first pre-selected intermediate location, and activate the transport system to arrive at the first pre-selected intermediate location within a threshold period of time of the UAV arrival time.

10. A method of providing aerial retail product delivery through a cooperation of mobile devices, comprising:
determining, through a first UAV control circuit of a first unmanned aerial vehicle (UAV) of a plurality of UAVs, adjustments to a final approach path between the first UAV and a first unmanned ground vehicle mobile control point (MCP) of a plurality of MCPs, which are each configured to move to a pre-selected intermediate location that is proximate to but distant from intended delivery locations of the one or more respective retail products carried by a corresponding one of the plurality of UAVs to complete the delivery to the respective delivery location, wherein the adjustments to the final approach path are to improve the alignment approach between the first UAV and the first MCP by applying a cooperative navigation between the first UAV and the first MCP as a function of both a first set of navigation data detected by a first coordination navigation sensor of the first UAV and that corresponds to an alignment approach between the first UAV and a first MCP of the plurality of MCPs, and a second set of navigation data detected by a first inbound navigation sensor of the first MCP as the first UAV approaches the first MCP;
implementing the adjustments to flight of the first UAV to modify the final approach path; and
directing the transfer of a first product from a first retail product carrying system of the first UAV to a first product receiving platform of the first MCP to cause the first MCP to transport to and deposit the first product at a first delivery location that is separate and distant from a first pre-selected intermediate location associated with the first MCP.

11. The method of claim 10, further comprising:
wirelessly receiving, directly from the first MCP, MCP adjustment instructions from the first MCP control circuit of the first MCP based on the second set of navigation data detected by the first inbound navigation sensor of the first MCP as the first UAV approaches the first MCP; and
wherein the determining the adjustments to the final approach path further comprises selecting the MCP adjustments instructions.

12. The method of claim 11, further comprising:
identifying, through a first MCP control circuit of the first MCP, a relative location of the first UAV relative to the first product receiving platform;
accessing an adjustment database that comprises associations between previous UAV locations relative to the first product receiving platform and previous advantageously implemented adjustments to previous final approach paths; and
identifying the MCP adjustment instructions from the adjustment database based on the relative location of the first UAV.

13. The method of claim 11, further comprising:
receiving, at a first MCP control circuit of the first MCP, confirmation of the intended transfer of the first product from the first UAV to the first MCP; and
controlling a receiving platform extending system of the first MCP to extend the first product receiving platform to a predefined height that is inaccessible to pets, people and livestock in preparation for receiving the first product from the first UAV.

14. The method of claim 11, further comprising:
receiving authentication data from the first MCP, and confirm an authentication of the first MCP as a prerequisite to the directing the transfer of the first product from the first retail product carrying system to the first product receiving platform of the first MCP.

15. The method of claim 10, further comprising:
wirelessly receiving, directly from the first MCP, the second set of navigation data detected by the first inbound navigation sensor of the first MCP as the first UAV approaches the first MCP;
comparing the first set of navigation data with the second set of navigation data; and
determining adjustments to a final approach path based on a difference between the first set of navigation data with the second set of navigation data.

16. The method of claim 10, further comprising:
broadcasting a request to implement a product transfer of the first product with one of multiple of the plurality of MCPs that are each within a threshold distance of the first delivery location, and
selecting the first MCP from the multiple MCPs based on at least a response to the broadcast received from the first MCP.

17. The method of claim 16, further comprising:
obtaining MCP capability data from the response to the broadcast from the first MCP;
accessing product transport parameters corresponding to the first product; and
confirming the first MCP is capable of receiving the first product and implementing the delivery of the first product to the first delivery location.

18. The method of claim 10, further comprising:
receiving, through a first MCP control circuit of the first MCP, a UAV arrival time;
determining an estimated travel time to the first pre-selected intermediate location; and
activating a ground based transport system of the first MCP to arrive at the first pre-selected intermediate location within a threshold period of time of the UAV arrival time.
